(19) United States
(12) Patent Application Publication
(10) Pub. No.: US 2019/0177503 A1
(43) Pub. Date: Jun. 13, 2019

(54) PHOTOACTIVATABLE MULTI-COMPONENT SYSTEMS FOR PRODUCING A FOAMED SILICONE COMPOSITION

(71) Applicant: Sonderhoff Chemicals GmbH, KöIn (DE)

(72) Inventors: Alexander Sistemich, Herzogenrath (DE); Volker Welsch, Köln (DE); Alfred Link, Pulheim (DE)

(21) Appl. No.: 15/780,042

(22) PCT Filed: Dec. 2, 2016
(86) PCT No.: PCT/IB2016/057300

§ 371 Date: May 30, 2018

(30) Foreign Application Priority Data
Dec. 3, 2015 (DE) 10 2015 121 053.3

(51) Int. Cl. C08J 9/14; C08J 9/12; C08J 9/00; C08G 77/12

(52) U.S. Cl. CPC C08J 9/142; C08J 9/125; C08J 9/0052; C08J 2383/04; C08J 2201/026; C08J 2203/10; C08J 2203/12; C08G 77/12

(57) ABSTRACT

The use of a multicomponent system comprising a) a polyorganosiloxane b) a polyhydrogenorganosiloxane c) a photoactivatable catalyst d) a blowing agent where the polyhydrogenorganosiloxane b) is assigned to a first component I), and the photoactivatable catalyst c) is assigned to a second component II), which are spatially separate from one another, for producing a seal attached by foaming to a component in situ, where a reaction mixture resulting through mixing of the components of the multicomponent system is irradiated with light, the blowing agent d) is a compound having at least one hydroxyl group or is a mixture of compounds having hydroxyl groups, and preferably is water, an alcohol or mixtures thereof.

The invention relates to a multicomponent system for producing a foamed silicone composition, to a reaction mixture for producing a foamed silicone composition, to the use of a multicomponent system of the invention or of a reaction mixture of the invention for producing a foamed silicone composition, to a method for producing a seal attached by foaming to a component in situ (“FIPFG” (Formed In Place Foam Gasket)), and to products, more particularly electronic components, housings, lamps, drums or filter housings, comprising a seal attached by foaming to a component in situ.

### BACKGROUND OF THE INVENTION

In order to seal housings of all kinds, examples being control cabinets, lamps, drums (packaging), filter housings, etc., elastic seals such as, for example, rubber rings of solid material, or else foamlike materials such as expanded rubber, have been used for decades. They are produced in an extremely wide variety of different forms and processes, and introduced into the housings.

A technology which has also become established for a number of decades is that of applying foaming and nonfoaming materials in liquid form directly to housing parts, where they react chemically and form a suitable sealing element. This technology is often referred to as “FIPG” (Formed In Place Gasket) or “FIPFG” (Formed In Place Foam Gasket) to represent a seal attached by foaming to a component in situ.

For many customary housings, such as control cabinets or packaging, only foamlike sealing materials are suitable, since the reduction in thickness of the housing walls (for reasons of economics) means that only moderate to low compression forces are permitted. In the majority of the fields of application of this kind, therefore, foamed seals are used, since they are softer than solid-material seals. In this context it is customary to employ polyurethanes or silicones as seal materials.

The use of silicone foams as a sealant is known from the prior art. Silicone foams are provided by numerous suppliers for a variety of applications. Examples of companies offering such products include Sonderhoff, Wacker (Elastosil silicone rubber) or Dow Chemical. Corresponding foams are described for example in EP 0 691 365 B1 and WO 00/46282.

In the production of seals attached by foaming to a component in situ (FIPFG) it is critical that the reactive mixture applied in liquid form is in the liquid state, prior to foaming, for a time sufficiently long to prevent contamination and/or blocking of the metering unit and also to allow coupling events on the sealing contour (in the case of housing seals, the contours in question are generally closed contours). The term used here is the “cream time” or “pot life”, which is to be as long as possible.

At the same time, for reasons of productivity, it is highly desirable for the liquid-applied mixture to be very rapidly dry and fully reacted, allowing the housing to be closed without detracting from the resilience of the freshly produced seal and causing permanent deformation of the seal. The term used here is “assembly time” or “tack-free time”, which is to be as short as possible.

The requirements with regard to the pot life and the assembly time are therefore contradictory. In order to fulfill these contradictory requirements, the patent literature has disclosed numerous specific catalysts and processes which lead to a maximally long cream time, followed by a maximally rapid, avalanche-like chemical reaction, through to complete curing.

DE 691 07 878 T2 describes, for example, a method for controlling the cure rate of silicone foam. In the method described, the cure time of a foamable silicone composition is controlled via an aqueous phosphoric ester/potassium hydroxide buffer system.

The reaction mixture is customarily applied by means of a robot to the part on which foam is to be placed. Processing takes place preferably at room temperature, with subsequent heating to shorten the tack-free time and in particular to achieve an optimum resilience (compression set) being customary.

In order to achieve rapid curing at room temperature and to keep the heating times and temperatures as short and as low as possible, respectively, a large quantity of platinum catalysts is required in the processes that are customary at present (see patent EP 0 691 365 B1).

Moreover, the fundamental requirement outlined above for a maximally long cream time and a maximally short tack-free time is inadequately fulfilled in the case of the customary silicone foam systems. It is desirable to accelerate the curing but without shortening the cream time of the reaction mixture. A shortened cream time leads to increased fouling of the mixing elements, leading in turn to increased maintenance expenditures. Moreover, a short cream time in the case of closed seals hinders the merging of start point and end point of the seal, resulting in an unwanted elevation of the seal in this region.

In order to prolong the cream time at the high platinum contents, therefore, inhibitors are additionally used which primarily prolong the cream time but without significantly prolonging the cure time. A disadvantage of these inhibitors, as well as prolonging the cure time, is that by comparison with the silicone base polymers they are significantly more expensive and therefore also increase the price of the formulation.

In order, with the silicone foam systems that are customarily in use at present, to tailor the pot life and the assembly time as precisely as possible to the desired values, therefore, there is a need for a high fraction of platinum catalysts, which at the same time are inhibited by inhibitors.

At the same time, a disadvantage of the silicone foam systems customarily used is that adapting the pot life to altered process conditions in ongoing operation is readily possible. At present, the silicone foam system used will have to be replaced completely by a silicone foam system with different, corresponding formulation.

A further disadvantage of the systems is that the reaction of the silicone foam systems can no longer be necessarily maintained after the individual components have been mixed together (activated). If an activated silicone foam system is already present in the feed hoses and/or nozzles of the plant, and if there is a system-related failure (e.g., a power outage), the mixing chamber and/or nozzles must be flushed and/or laboriously cleaned after the full reaction of the systems.

### SUMMARY OF THE INVENTION

The primary problem addressed by the present invention is that of providing a silicone foam system wherein the pot life and assembly time can be simply controlled.

A further problem addressed by the present invention is that of reducing the costs of the silicone foam system.

Additional problems addressed by the present invention are apparent from the description hereinafter and also, in particular, from the appended claims of the patent.

### DESCRIPTION OF PREFERRED EMBODIMENTS

These problems are solved in accordance with the invention by means of a multicomponent system for producing a foamed silicone composition, comprising or consisting of
a) a polyorganosiloxane
b) a polyhydrogenorganosiloxane
c) a photoactivatable catalyst
d) a blowing agent
e) optionally one, two, three or more fillers
f) optionally additives, preferably additives for cell control in foams,
   where the polyhydrogenorganosiloxane b) is assigned to a first component I), and the photoactivatable catalyst c) is assigned to a second component II), which are spatially separate from one another.

It has surprisingly emerged that through the use of a photoactivatable catalyst in multicomponent systems for producing a foamed silicone composition, it is possible to adjust the pot life and assembly time very accurately. This was unexpected particularly with a foamed silicone composition, the assumption hitherto having been that transirradiation with light, because of the strong refraction resulting from the foam structure, was not possible and therefore that it was not possible to achieve rapid full reaction within the desired assembly time.

By a “multicomponent system” is meant, generally speaking, a system which consists of two, three, four or more reactive components, separated spatially from one another, which for reaction are mixed and, where necessary, are treated further. The individual constituents of the multicomponent system of the invention are therefore divided over two, three or four or more separate components, with the polyhydrogenorganosiloxane b) being assigned to a first component I) and the photoactivatable catalyst c) being assigned to a second component II). A component is therefore spatially separate from other components and may consist of a plurality of constituents.

The photoactivatable catalyst is present as an additive in at least one component, where it is inactive. After the mixing of all of the components, the photoactivatable catalyst, in the absence of activation by light radiation (preferably UV radiation), remains approximately inactive, and the pot life of the reaction mixture formed by mixing of the components is in the region of several hours to days. Preferred in accordance with the invention for producing a foamed silicone composition are multicomponent systems wherein the pot life of the reaction mixture formed by the mixing of all the components is more than one hour, preferably more than four hours, more preferably more than 12 hours, very preferably more than 24 hours, unless the reaction mixture is activated by light irradiation (storage in the absence of light).

Preferred in accordance with the invention is a multicomponent system which is a two-component system, meaning that the individual constituents are divided over two components. Two-component systems are the most common in practice, since in ongoing operation there are only two components that must be used and monitored. This represents a considerable easing of the logistics and storage of the multicomponent system.

Preferred in accordance with the invention is a multicomponent system wherein the blowing agent d) is a compound having one, two or more hydroxyl groups or is a mixture of compounds having one, two or more hydroxyl groups, and preferably is water, an alcohol or mixtures thereof.

In our own investigations it has emerged that these blowing agents are the most suitable, since with these blowing agents the foaming is induced only by the activation of the photoactivatable catalyst c).

Particularly preferred is a multicomponent system of the invention wherein the alcohol is a mono-, di- or polyhydric alcohol having 1 to 10 carbon atoms, preferably methanol, ethanol, propanol, preferably isopropanol, butanol, preferably 1-butanol, 1,4-butanediol, lauryl alcohol, octyl alcohol, 2-ethylhexanol or ethylene glycol.

In one preferred embodiment of the multicomponent system of the invention, use is made as blowing agent d) of a mixture of water and a mono- or dihydric alcohol having 1 to 10 carbon atoms, preferably a mixture of water and an alcohol selected from the group consisting of methanol, ethanol, propanol, preferably isopropanol, butanol, preferably 1-butanol, 1,4-butanediol, lauryl alcohol, octyl alcohol, 2-ethylhexanol or ethylene glycol, more preferably a mixture of water and butanol, preferably 1-butanol.

In another, likewise preferred embodiment of the multicomponent system of the invention, water alone is used as blowing agent d).

Water in particular, and the low molecular mass alcohols listed above are notable for their benign toxicity. In our own investigations, moreover, it emerged that in the case of small molecules in particular, it is possible to achieve a high blowing gas yield/foam yield per unit weight of blowing agent d) employed.

In the context of the present invention a preferred multicomponent system of the invention is one wherein the blowing agent d) amounts to at least 0.01 and/or at most 10.0 wt %, preferably at least 0.05 and/or at most 5.0 wt %, more preferably at least 0.1 and/or at most 2.0 wt %, very preferably at least 0.3 and/or at most 1.4 wt %, based on the total amount of the multicomponent system.

Through the use of a blowing agent it is possible for the multicomponent system to form a foam after all of the components have been mixed together, with formation of a reaction mixture, and after subsequent activation with light. Without the presence of a blowing agent, or with inadequate amounts of a blowing agent present, no foam is formed and only an unfoamed silicone composition is obtained. In particular, the presence of traces (less than 0.001 wt %) of a blowing agent is not sufficient to allow formation of a foam.

Preferred in accordance with the invention is a multicomponent system wherein the blowing agent d) is assigned to the second component II).

According to one preferred embodiment of the present invention, the polyorganosiloxane a) has on average at least two unsaturated organic groups per molecule, preferably on average at least two vinyl groups per molecule, more preferably on average two terminal vinyl groups per molecule.

The skilled person is aware that in the case of polymers, functionalization, or end-group functionalization with, for example, vinyl groups, does not always proceed to completion, with the consequence that even after functionalization has been carried out, there are polymers remaining which are unfunctionalized, only singly functionalized, or more than doubly functionalized. The expression “on average at least two groups per molecule” therefore means that in the case of the constituent employed, the individual polymer molecules are functionalized on average, over all the polymer molecules of the same type, with at least two groups.

Preference is given to a multicomponent system of the invention where the polyorganosiloxane a) is a polyalkylsiloxane, polyphenylsiloxane or polyfluoroalkyl-siloxane, preferably a polydimethylsiloxane.

Likewise preferred is a multicomponent system of the invention where the polyorganosiloxane a) has a viscosity of 25 to 1 000 000 mPa s, preferably 50 to 200 000 mPa s, more preferably 1000 to 100 000 mPa s (20° C.).

Polyorganosiloxanes a) particularly preferred in the context of the present invention are described in more detail in paragraphs [0004] to [0007] of the European patent with the number EP 1 817 372 B1, where they are particularized further in paragraphs [0008] to [0021]. In this regard, reference is made to the European patent with the number EP 1 817 372 B1, whose paragraphs [0004] to [0007] and [0008] to [0021] are hereby incorporated into this specification.

Particularly preferred is a multicomponent system of the invention wherein the polyorganosiloxane a) is a polydimethylsiloxane in which the methyl groups are present at not less than 90 mol %, based on the Si atoms, preferably 90 to 99.99 mol %.

In order to adjust the mechanical properties, such as the tear resistance of the foamed silicone composition, and/or in order to adjust the viscosity of the components, one preferred embodiment of the present invention usefully employs blends of two, three, four or more different polyorganosiloxanes differing in alkenyl content and/or in chain length.

It is likewise preferred if the polyorganosiloxane a) is assigned to the first component I) and/or to the second component II).

Preferred, furthermore, is a multicomponent system of the invention where the polyhydrogenorganosiloxane b) is a linear, cyclic or branched SiH-containing polyorganosiloxane having on average at least two SiH groups per molecule, preferably at least five SiH groups per molecule, more preferably at least ten SiH groups per molecule.

With particular preference, a polyhydrogenorganosiloxane b) used in accordance with the invention has an SiH content of more than 2 mmol/g, preferably more than 7 mmol/g, more preferably an SiH content of more than 10 mmol/g, especially preferably an SiH content of 14 to 16 mmol/g, based on the total weight of the polyhydrogenorganosiloxane b) used in each case.

Particularly preferred is a multicomponent system of the invention wherein the polyhydrogenorganosiloxane b) has a viscosity at 25° C. of between 5 and 35 mm²/s, preferably a viscosity of between 10 and 20 mm²/s, more preferably a viscosity of between 13 and 18 mm²/s, very preferably a viscosity of 15 mm²/s.

One embodiment of the present invention preferably uses blends of two, three, four or more different polyhydrogenorganosiloxanes. In that case it is particularly preferred if at least one of the polyhydrogenorganosiloxanes used has
i) on average at least two SiH groups per molecule, preferably at least five SiH groups per molecule, more preferably at least ten SiH groups per molecule,
   and/or
ii) an SiH content of more than 2 mmol/g, preferably more than 7 mmol/g, more preferably an Si—H content of more than 10 mmol/g, especially preferably an SiH content of 14 to 16 mmol/g, based on the total weight of the polyhydrogenorganosiloxane b) used,
   and/or
   iii) a viscosity at 25° C. of between 5 and 30 mm²/s, preferably a viscosity of between 10 and 20 mm²/s, more preferably a viscosity of between 13 and 18 mm²/s, very preferably a viscosity of 15 mm²/s.

Particularly preferred is a multicomponent system of the invention where the polyhydrogenorganosiloxane b) is a methylhydrogenpolysiloxane or a trimethylsiloxy-endstopped polydimethylhydrogenmethylsiloxane.

Further polyhydrogenorganosiloxanes b) preferred in the context of the present invention are described in more detail in paragraphs [0022] and [0023] of the European patent with the number EP 1 817 372 B1, where they are particularized further in paragraphs [0024] to [0040]. In this regard, reference is made to the European patent with the number EP 1 817 372 B1, whose paragraphs [0022] to [0023] and [0024] to

are hereby incorporated into this specification.

Particularly preferred is a multicomponent system of the invention where the one or the two, three or more fillers is or are selected from the group consisting of functional silicone resins (resin reinforcement), micronized polyethylene (PE), micronized polypropylene (PP), micronized natural wax, modifications of micronized polyethylene (PE), micronized polypropylene (PP) or micronized natural wax, chopped polyethylene fibers, chopped polypropylene fibers, micronized hollow thermoplastic spheres, PMMA powder, Teflon powder, SiO2 nanoparticles, fumed silicas, precipitated silicas, talc, titanium dioxide, magnesium oxide, zinc oxide, iron oxide, chromium oxide, zirconium oxide, aluminum oxide, aluminum hydroxide, glass fibers, microscopic glass spheres, hollow glass spheres, quartz, clay, lithopones, zirconium silicate, silicon dioxide aerogel, diatomaceous earth, calcium carbonate, finely ground cristobalites, feldspar, feldspar derivatives, mica, chalks, carbon black, and graphite.

Likewise preferred is a multicomponent system of the invention wherein at least one of the fillers comprises or consists of nanoscale or microscale, functional silicone resin particles functionalized with more than two unsaturated organic groups, preferably with more than two vinyl groups.

Preferred in accordance with the invention is a multicomponent system wherein the one or the two, three or more fillers has or have a BET surface area of 50 to 400 m²/g.

Preferred in accordance with the invention is a multicomponent system wherein the one or two, three or more of the two, three or more fillers are surface-modified with at least one reactive silane.

On crosslinking of the individual constituents, surface-modified fillers, particularly if surface-modified with silanes, are incorporated into the polymer system and thus improve properties including the strength of the foamed silicone composition produced.

Preferred in accordance with the invention is a multicomponent system wherein the one or two, three or more of the two, three or more fillers are hydrophobic.

Preferred in accordance with the invention is a multicomponent system wherein the one or the two, three or more fillers e) is or are each assigned to the first component I) and/or to the second component II).

Preferred in accordance with the invention is a multicomponent system wherein the photoactivatable catalyst c) is a photoactivatable hydrosilylation catalyst which comprises at least one metal selected from the group consisting of platinum, palladium, rhodium, nickel, iridium, and ruthenium, preferably platinum.

Preferred in accordance with the invention is a multicomponent system wherein the photoactivatable catalyst c) is an organometallic compound.

Preferred in accordance with the invention is a multicomponent system wherein the photoactivatable catalyst c) is an η-diolefin-σ-aryl-platinum complex, a (η-diolefin)-(sigma-aryl)-platinum complex or a (η-diolefin)-(sigma-alkyl)-platinum complex.

Preferred in accordance with the invention is a multicomponent system wherein the photoactivatable catalyst c) is selected from the group consisting of η⁵-(methylcyclopentadienyl)trimethylplatinum, η⁵-(cyclopentadienyl)trimethylplatinum, η⁵-(cyclopentadienyl)ethyldimethylplatinum, η⁵-(cyclopentadienyl)triethylplatinum, η⁵-(cyclopentadienyl)triallylplatinum, η⁵-(cyclopentadienyl)tripentylplatinum, η⁵-(cyclopentadienyl)trihexylplatinum, η⁵-(trimethylsilylcyclopentadienyl)trimethyl-platinum, η⁵-(phenyldimethylsilylcyclopentadienyl)trimethylplatinum, η⁵-(cyclopentadienyl)acetyldimethylplatinum, η⁵-(cyclopentadienyl)diethylmethyl-platinum, η⁵-(cyclopentadienyl)triisopropylplatinum, η⁵-(cyclopentadienyl)tri(2-butyl)platinum, η⁵-(cyclopentadienyl)triallylplatinum, η⁵-(cyclopentadienyl)trinonyl-platinum, η⁵-(cyclopentadienyl)tridodecylplatinum, η⁵-(cyclopentadienyl)tricyclopentyl-platinum, η⁵-(cyclopentadienyl)tricyclohexylplatinum, η⁵-(chlorocyclopentadienyl)-trimethylplatinum, η⁵-(fluorocyclopentadienyl)trimethylplatinum, η⁵-(cyclopentadienyl)-dimethylbenzylplatinum, η⁵-(triethylsilylcyclopentadienyl)trimethylplatinum, η⁵-(dimethylphenylsilylcyclopentadienyl)trimethylplatinum, η⁵-(methyldiphenylsilyl-cyclopentadienyl)trimethylplatinum, η⁵-(triphenylsilylcyclopentadienyl)trihexylplatinum, η⁵-[1,3-bis(trimethylsilyl)cyclopentadienyl]trimethylplatinum, η⁵-(dimethyloctadecylsilyl-cyclopentadienyl)trimethylplatinum, 1,3-bis[η⁵-(cyclopentadienyl)-trimethylplatinum]tetramethyldisiloxane, 1,3-bis[η⁵-(cyclopentadienyl)trimethyl-platinum]dimethyldiphenyldisiloxane, 1,3-bis[η⁵-(cyclopentadienyl)dimethylphenyl-platinum]tetramethyldisiloxane, 1,3,5-tris[η⁵-(cyclopentadienyl)trimethylplatinum]-pentamethyltrisiloxane, 1,3,5,7-tetra[η⁵-(cyclopentadienyl)trimethylplatinum]-heptamethyltetrasiloxane, (methoxycyclopentadienyl)trimethylplatinum, (ethoxymethylcyclopentadienyl)ethyldimethylplatinum, (methoxycarbonyl-cyclopentadienyl)trimethylplatinum, (1,3-dimethylcyclopentadienyl)trimethylplatinum, (methylcyclopentadienyl)triisopropylplatinum, (1,3-diacetylcyclopentadienyl)diethyl-methylplatinum, (1,2,3,4,5-pentachlorocyclopentadienyl)trimethylplatinum, (phenyl-cyclopentadienyl)trimethylplatinum, η⁵-(cyclopentadienyl)acetyldimethylplatinum, η⁵-(cyclopentadienyl)propionyldimethylplatinum, η⁵-(cyclopentadienyl)acryloyldimethyl-platinum, η⁵-(cyclopentadienyl)di(methacryloyl)ethylplatinum, η⁵-(cyclo-pentadienyl)dodecanoyldimethylplatinum, trimethylplatinumcyclopentadienyl-terminal polysiloxane, (1,5-cyclooctadiene)diphenylplatinum, (1,3,5,7-cyclooctatetraene)-diphenylplatinum, (2,5-NBD)diphenylplatinum, (3a,4,7,7a-tetrahydro-4,7-methanoindene)diphenylplatinum, (1,5-cyclooctadiene)-bis(4-methylphenyl)platinum, (1,5-cyclooctadiene)-bis(2-methylphenyl)platinum, (1,5-cyclooctadiene)-bis(2-methoxyphenyl)platinum, (1,5-cyclooctadien)-bis(3-methoxyphenyl)platinum, (1,5-cyclooctadiene)-bis(4-phenoxyphenyl)platinum, (1,5-cyclooctadiene)-bis(4-methylthiophenyl)platinum, (1,5-cyclooctadiene)-bis(3-chlorophenyl)platinum, (1,5-cyclooctadiene)-bis(4-fluorophenyl)platinum, (1,5-cyclooctadiene)-bis(4-bromo-phenyl)platinum, (1,5-cyclooctadiene)-bis(4-trifluoromethylphenyl)platinum, (1,5-cyclooctadiene)-bis(3-trifluoromethylphenyl)platinum, (1,5-cyclooctadien)-bis(2,4-bis(trifluoromethyl)phenyl)platinum, (1,5-cyclooctadiene)-bis(4-dimethylamino-phenyl)platinum, (1,5-cyclooctadiene)-bis(4-acetylphenyl)platinum, (1,5-cyclooctadiene)-bis(trimethylsilyloxyphenyl)platinum, (1,5-cyclooctadiene)-bis(trimethylsilylphenyl)platinum, (1,5-cyclooctadiene)-bis(pentafluorophenyl)platinum, (1,5-cyclooctadiene)-bis(4-benzylphenyl)platinum, (1,5-cyclooctadiene)-bis(1-naphthyl)platinum, (1,5-cyclooctadiene)naphthylphenylplatinum, (1,5-cyclooctadiene)-bis(2H-chromen-2-yl)platinum, (1,5-cyclooctadiene)-bis(xanthene-1-phenyl)platinum, (1,3,5-cycloheptatriene)diphenylplatinum, (1-chloro-1,5-cyclooctadiene)diphenylplatinum, (1,5-dichloro-1,5-cyclooctadiene)diphenylplatinum, (1-fluoro-1,3,5,7-cyclooctatetraene)diphenylplatinum, (1,2,4,7-tetramethyl-1,3,5,7-cyclooctatetraene)-bis(4-methylphenyl)platinum, (7-chloro-2,5-N BD)diphenylplatinum, (1,3-cyclohexadiene)diphenylplatinum, (1,4-cyclohexadiene)diphenylplatinum, (2,4-hexadiene)diphenylplatinum, (2,5-heptadiene)diphenylplatinum, (1,3-dodecadiene)-diphenylplatinum, bis[η2-2-(2-propenyl)phenyl]platinum, bis[η2-2-(ethenylphenyl)platinum, bis[η2-2-(cyclohexen-1-yl methyl)phenyl]platinum, (1,5-cyclooctadiene)Pt(methyl)2, (1,5-cyclooctadiene)Pt(benzyl)2, and (1,5-cyclooctadiene)Pt(hexyl)2, preferably wherein the photoactivatable catalyst is η⁵-(methylcyclopentadienyl)trimethylplatinum.

Preferred in accordance with the invention is a multicomponent system wherein the photoactivatable catalyst c) is photoactivatable at a wavelength of between 180 and 700 nm, preferably photoactivatable at a wavelength of between 200 and 500 nm. It is preferred if the photoactivatable catalyst c) is activatable in UV light. The fraction of UV light in normal sunlight or in illumination light in production halls is small and it is therefore possible that the components of the multicomponent system of the invention or of the reaction mixture of the invention produced from that system is not activated immediately, even if irradiated with light of the kind not always avoidable in normal operation.

Preferred in accordance with the invention is a multicomponent system wherein the fraction of the photoactivatable catalyst, based on the platinum present, is 0.5 to 60 ppm, preferably 1 to 40 ppm, more preferably 2 to 20 ppm, based on the total weight of the multicomponent system.

In one embodiment of the multicomponent system of the invention, the fraction of the photoactivatable catalyst is 0.5 to 3 wt %, preferably 0.75 to 2.5 wt %, more preferably 1 to 2 wt %, based on the total weight of the multicomponent system.

It has emerged that even for small amounts of the platinum catalyst it is possible to achieve a sufficiently short assembly time, since the presence of inhibitors need no longer be compensated by a large amount of platinum catalyst. Because of the particularly small amounts of platinum, on the one hand it is possible to achieve a considerable reduction in the price of the multicomponent system of the invention, and on the other hand the platinum content in the foamed silicone composition produced is smaller. A small platinum content in the foamed silicone composition produced may prolong the lifetime of the silicone composition, since aging of the silicone composition, induced by the platinum, might be reduced. While platinum is indeed required for the foaming and the crosslinking of the multicomponent system, it may nevertheless also accelerate unwanted aging reaction in the finished product.

Preferred in accordance with the invention is a multicomponent system where the multicomponent system comprises no buffers and/or inhibitors, more particularly no tetravinyltetramethylcyclotetrasiloxane (vinyl D4) or ethynylcyclohexanol (ECH).

Preferred in accordance with the invention is a multicomponent system for producing a seal attached by foaming to a component in situ.

Likewise preferred in accordance with the invention is a multicomponent system which is a two-component system where
A) the first component I) contains

| | |
|---|---|
| 0 to 99 wt % | of polyorganosiloxane a) |
| 1 to 100 wt % | of polyhydrogenorganosiloxane b) |
| 0 to 90 wt % | of fillers e) |
| 0 to 10 wt % | of additive f), preferably additives for cell control |
| | in foams, based on the total weight of the first |
| | component I) |

and/or
B) the second component II) contains

| | |
|---|---|
| 10 to 99.9 wt % | of polyorganosiloxane a) |
| 0.5 to 60 ppm, | based on platinum, of photoactivatable catalyst c) |
| 0.01 to 10.0 wt %, | preferably 0.1 to 5 wt %, more preferably 0.2 to |
| | 3.0 wt %, especially preferably 0.3 to 2 wt % of |
| | blowing agents d), |
| 0 to 90 wt % | of fillers e) |
| 0 to 10 wt % | of additives f), preferably additives for cell control |
| | in foams, based on the total weight of the second |
| | component II). |

Likewise preferred in accordance with the invention is a multicomponent system where, after all of the components have been mixed together, it is possible to produce a reaction mixture with the following fractions:

| | |
|---|---|
| 10 to 97.4 wt % | of polyorganosiloxane a), |
| 2 to 50 wt % | of polyhydrogenorganosiloxane b), |
| 0.5 to 60 ppm, | based on platinum of photoactivatable catalyst c), |
| 0.01 to 10.0 wt %, | preferably 0.1 to 5 wt %, more preferably 0.2 to 3.0 |
| | wt %, especially preferably 0.3 to 2 wt %, of |
| | blowing agents d), |
| 0 to 90 wt % | of fillers e), |
| 0 to 10 wt % | of additives f), preferably additives for cell control |
| | in foams, based on the total weight of the |
| | reaction mixture. |

A further aspect of the present invention relates to a reaction mixture for producing a foamed silicone composition, produced by mixing all the components of the multicomponent system of the invention.

Preference is given to a reaction mixture of the invention which is produced by mixing together a two-component system, where the first component I) and the second component II) are mixed in a ratio of 100:1 to 1:100 parts by weight, preferably in a ratio of 10:1 to 1:10 parts by weight, more preferably in a ratio of 3:1 to 1:3.

Preferred in accordance with the invention is a reaction mixture for producing a seal attached by foaming to a component in situ.

A further aspect in connection with the present invention relates to the use of a multicomponent system of the invention or of a reaction mixture of the invention for producing a foamed silicone composition, preferably for producing a seal attached by foaming to a component in situ.

Preferred in accordance with the invention is the use of the embodiments identified earlier on above as being preferred or more preferred, for the multicomponent system of the invention or for the reaction mixture of the invention, where preferably two or more of the aspects or corresponding features described for the multicomponent system or for the reaction mixture are combined with one another.

Preferred in accordance with the invention is the use of a multicomponent system comprising
a) a polyorganosiloxane
b) a polyhydrogenorganosiloxane
c) a photoactivatable catalyst
d) a blowing agent
where the polyhydrogenorganosiloxane b) is assigned to a first component I), and the photoactivatable catalyst c) is assigned to a second component II), which are spatially separate from one another,
for producing a seal attached by foaming to a component in situ, where a reaction mixture resulting through mixing of the components of the multicomponent system is irradiated with light.

Preferred in accordance with the invention is the use of a multicomponent system where the blowing agent d) is a compound having at least one hydroxyl group or is a mixture of compounds having hydroxyl groups, and preferably is water, an alcohol or mixtures thereof.

Likewise preferred in accordance with the invention is the use of a multicomponent system where the alcohol is a mono-, di- or polyhydric alcohol having 1 to 10 carbon atoms, preferably methanol, ethanol, propanol, preferably isopropanol, butanol, preferably 1-butanol, 1,4-butanediol, lauryl alcohol, octyl alcohol, 2-ethylhexanol or ethylene glycol.

Likewise preferred in accordance with the invention is the use of a multicomponent system where the amount of the blowing agent d) is
0.01 to 10.0 wt %, preferably 0.1 to 5 wt %, more preferably 0.2 to 3.0 wt %, especially preferably 0.3 to 2 wt %,
based on the total amount of the multicomponent system.

Likewise preferred in accordance with the invention is the use of multicomponent system where the blowing agent d) is assigned to the second component (II).

Likewise preferred in accordance with the invention is the use of multicomponent system where the polyorganosiloxane a) has on average at least two unsaturated organic groups per molecule, preferably on average at least two vinyl groups per molecule, more preferably on average two terminal vinyl groups per molecule.

Likewise preferred in accordance with the invention is the use of multicomponent system where the photoactivatable catalyst is a photoactivatable hydrosilylation catalyst which comprises at least one metal selected from the group consisting of platinum, palladium, rhodium, nickel, iridium, and ruthenium, preferably platinum,
and/or
where the photoactivatable catalyst is an organometallic compound
and/or
where the photoactivatable catalyst is an η-diolefin-σ-aryl-platinum complex, a (η-diolefin)-(sigma-aryl)-platinum complex or a (η-diolefin)-(sigma-alkyl)-platinum complex.

Likewise preferred in accordance with the invention is the use of multicomponent system for producing electronic components, housings, preferably control cabinets, lamps, barrel housings or filter housings.

Likewise preferred in accordance with the invention is the use of the multicomponent system where the multicomponent system additionally comprises one, two, three or more fillers.

Likewise preferred in accordance with the invention is the use of the multicomponent system where the multicomponent system additionally comprises additives, preferably additives for cell control in foams.

Likewise preferred in accordance with the invention is the use of the multicomponent system where the polyorganosiloxane a) is a polydimethylsiloxane in which the methyl groups are present at not less than 90 mol %, based on the Si atoms, preferably 90 to 99.99 mol %.

Likewise preferred in accordance with the invention is the use of the multicomponent system where the polyorganosiloxane a) is assigned to the first component I) and/or to the second component II).

Likewise preferred in accordance with the invention is the use of the multicomponent system where the polyhydrogenorganosiloxane b) has an SiH content of more than 2 mmol/g, preferably more than 7 mmol/g, more preferably an SiH content of more than 10 mmol/g, especially preferably an SiH content of 14 to 16 mmol/g, based on the total weight of the polyhydrogenorganosiloxane b) used in each case.

Likewise preferred in accordance with the invention is the use of the multicomponent system where the light has a wavelength of between 180 and 700 nm, more preferably of between 200 and 500 nm.

A preferred aspect of the present invention relates to a method for producing a seal attached by foaming to a component in situ, comprising the following steps:
providing or producing a multicomponent system of the invention,
mixing the components of the multicomponent system provided or produced, to form a reaction mixture of the invention,
applying the reaction mixture to the surface of a component, and
irradiating the reaction mixture with light, preferably with light of a wavelength of between 180 and 700 nm, more preferably with a light of a wavelength of between 200 and 500 nm.

A preferred method of the invention additionally contains the following step:
air loading for nucleation.

The reaction mixture is irradiated with light, preferably in this case with a UV radiation source, preferably a UV radiation source selected from the group consisting of UV-LED lamps, UV lasers, xenon lamps which can be operated as flash lamps, mercury lamps undoped or doped with iron or gallium, black-light lamps, and excimer lamps.

A further aspect of the present invention relates to a seal attached by foaming to a component in situ, producible
a) by a method of the invention
and/or
b) from a multicomponent system of the invention
and/or
c) from a reaction mixture of the invention.

The seals of the invention attached by foaming to a component in situ differ from the seals obtainable to date in a low platinum content and in the absence of buffers and/or inhibitors. Foamed seals available to date have had a high platinum content and contained the inhibitors and/or buffers needed for control of the pot life. In the finished seal attached by foaming, however, these components are no longer needed and they can lead to unwanted secondary reactions and hence to more rapid aging of the seal. This process is accelerated in particular if the seals attached by foaming are exposed to external influences, such as light or chemicals.

Preferred in accordance with the invention is a seal attached by foaming to a component in situ wherein the platinum content is not more than 60 ppm, preferably not more than 40 ppm, more particularly not more than 20 ppm, based on the total weight of the seal.

Preferred in accordance with the invention is a seal attached by foaming to a component in situ wherein the platinum content is 0.5 to 60 ppm, preferably 1 to 40 ppm, more particularly 2 to 20 ppm, based on the total weight of the seal.

Likewise preferred in accordance with the invention is a seal attached by foaming to a component in situ where the seal contains no buffers and/or inhibitors, more particularly no tetravinyltetramethylcyclotetrasiloxane (vinyl D4) or ethynylcyclohexanol (ECH).

A further aspect in connection with the present invention relates to products, more particularly electronic components, housings, preferably control cabinets, lamps, drums (packaging) or filter housings, comprising a seal of the invention attached by foaming to a component in situ, preferably produced by a method of the invention.

In the context of the present invention, it is preferred for a plurality of the aspects identified above as being preferred to be actualized simultaneously; especially preferred are the combinations of such aspects and of the corresponding features that are evident from the appended claims.

The examples which follow illustrate the invention; unless otherwise indicated, all figures are based on weight.

### Example 1

TABLE 1
Component I)

| | | Amount weight |
|---|---|---|
| Trade name | Chemical basis | percentages |
| Silopren U 65, | Vinyl-group-containing | 84.40 |
| Momentive | polydimethylsiloxane, viscosity | |
| | 20° C. about 65 000 mPa · s | |
| HDK-2000, Wacker | Hydrophobized finely divided | 4.30 |
| | silica | |
| Oil MH 15, | Methylhydrogenpolysiloxane | 11.30 |
| Momentive | | |

TABLE 2
Component II)

| | | Amount weight |
|---|---|---|
| Trade name | Chemical basis | percentages |
| Silopren U 65, | Vinyl-group-containing | 93.82 |
| Momentive | polydimethylsiloxane, viscosity | |
| | 20° C. about 65 000 mPa · s | |
| | Water | 0.90 |
| HDK-2000, Wacker | Hydrophobized finely divided | 5.20 |
| | silica | |
| UV LSR Cat, | Platinum catalyst, UV activatable | 0.08 |
| Momentive | | |

Mixing ratio component II: Component I by parts by weight = 1.4:1.

To produce component I), the constituents of component I indicated in Table 1 above are mixed in a stirring pot. To produce component II), the constituents of component II) indicated in Table 2 above are mixed in a stirring pot in the absence of light. The components I) and II) produced are stored separately from one another in the absence of light pending their use.

Components I) and II) are subsequently mixed with one another in a mixing ratio by parts by weight of 1:1.4 (component I:component II). The reaction mixture thus produced is applied to a housing part in the form of a seal attached by foaming to a component in situ (“FIPFG”).

The applied reaction mixture is exposed using a UV flash lamp (xenon) (from Blässing, Essen), with a power delivery of 34.9 J/single flash at 12.5 Hz at a distance of 40 mm for 120 sec at 25° C.

Following exposure, a seal attached by foaming to a component in situ (“FIPFG”) is formed on the housing part.

Before being exposed with the UV flash lamp, the reaction mixture produced can be left to stand for several hours without the mixture curing or foaming. Following exposure, the foamed seal is formed within a few seconds to minutes.

### Example 2

TABLE 3
Component I)

| | | Amount weight |
|---|---|---|
| Trade name | Chemical basis | percentages |
| Silopren U 10, | Vinyl-group-containing | 63.20 |
| Momentive | polydimethylsiloxane, viscosity | |
| | 20° C. about 10 000 mPa · s | |
| Oil MH 15, | Methylhydrogenpolysiloxane | 11.60 |
| Momentive | | |
| Silopren U base | QM resin-reinforced, vinyl-group- | 18.70 |
| mixture H6, | containing polydimethylsiloxane, | |
| Momentive | viscosity 20° C. about 6000 mPa · s | |
| CAB-O-SIL TS | Fumed silica surface-treated with | 6.50 |
| 720, Cabot | polydimethlysiloxane | |

TABLE 4
Component II)

| | | Amount weight |
|---|---|---|
| Trade name | Chemical basis | percentages |
| Silopren U 10, | Vinyl-group-containing | 61.00 |
| Momentive | polydimethylsiloxane, viscosity | |
| | 20° C. about 10 000 mPa · s | |
| Silopren U | QM resin-reinforced, vinyl-group- | 12.00 |
| base mixture | containing polydimethylsiloxane, | |
| H6, Momentive | viscosity 20° C. about 6000 mPa · s | |
| Silopren C 0.5, | Hydroxyl-terminated dimethylsiloxane | 18.70 |
| Momentive | | |
| 1-Butanol | 1-Butanol | 1.90 |
| CAB-O-SIL TS | Fumed silica surface-treated with | 5.90 |
| 720, Cabot | polydimethylsiloxane | |
| UV LSR Cat, | Platinum catalyst, UV activatable | 0.08 |
| Momentive | | |
| Water | Water | 0.42 |

To produce component I), the constituents of component I indicated in Table 3 above are mixed in a stirring pot. To produce component II), the constituents of component II) indicated in Table 4 above are mixed in a stirring pot in the absence of light. The components I) and II) produced are stored separately from one another in the absence of light pending their use.

Components I) and II) are subsequently mixed with one another in a mixing ratio by parts by weight of 1:1. The reaction mixture thus produced is applied to a housing part in the form of a seal attached by foaming to a component in situ (“FIPFG”).

The applied reaction mixture is exposed using a UV flash lamp (xenon) (from Blässing, Essen), with a power delivery of 34.9 J/single flash at 12.5 Hz at a distance of 40 mm for 120 sec at 25° C.

Following exposure, a seal attached by foaming to a component in situ (“FIPFG”) is formed on the housing part.

Before being exposed with the UV flash lamp, the reaction mixture produced can be left to stand for several hours without the mixture curing or foaming. Following exposure, the foamed seal is formed within a few seconds to minutes.

### Embodiments of the Invention:

1. A multicomponent system for producing a foamed silicone composition, comprising
   a) a polyorganosiloxane
   b) a polyhydrogenorganosiloxane
   c) a photoactivatable catalyst
   d) a blowing agent
   e) optionally one, two, three or more fillers
   f) optionally additives, preferably additives for cell control in foams,
   where the polyhydrogenorganosiloxane b) is assigned to a first component I), and the photoactivatable catalyst c) is assigned to a second component II), which are spatially separate from one another.
2. The multicomponent system of embodiment 1, characterized in that the blowing agent d) is a compound having at least one hydroxyl group or is a mixture of compounds having hydroxyl groups, and preferably is water, an alcohol or mixtures thereof
and/or
characterized in that the blowing agent d) amounts to
0.01 to 10.0 wt %, preferably 0.1 to 5 wt %, more preferably 0.2 to 3.0 wt %, especially preferably 0.3 to 2 wt %,
based on the total amount of the multicomponent system.
3. The multicomponent system of any of the preceding embodiments, characterized in that the polyorganosiloxane a) has on average at least two unsaturated organic groups per molecule, preferably on average at least two vinyl groups per molecule, more preferably on average two terminal vinyl groups per molecule.
4. The multicomponent system of any of the preceding embodiments, characterized in that the photoactivatable catalyst is a photoactivatable hydrosilylation catalyst which comprises at least one metal selected from the group consisting of platinum, palladium, rhodium, nickel, iridium, and ruthenium, preferably platinum,
and/or
characterized in that the photoactivatable catalyst is an organometallic compound
and/or characterized in that the photoactivatable catalyst is an η-diolefin-σ-aryl-platinum complex, a (η-diolefin)-(sigma-aryl)-platinum complex or a (η-diolefin)-(sigma-alkyl)-platinum complex.
5. A reaction mixture for producing a foamed silicone composition, produced by mixing all the components of the multicomponent system of one of embodiments 1 to 4.
6. The reaction mixture of embodiment 5 or multicomponent system of any of embodiments 1 to 4 for producing a seal attached by foaming to a component in situ.
7. The use of a multicomponent system of any of embodiments 1 to 4 or of a reaction mixture of either of embodiments 5 and 6 for producing a foamed silicone composition, preferably for producing a seal attached by foaming to a component in situ.
8. A method for producing a foamed silicone composition, preferably for producing a seal attached by foaming to a component in situ, comprising the following steps:
providing or producing a multicomponent system of any of embodiments 1 to 4,
mixing the components of the multicomponent system provided or produced, to form a reaction mixture,
applying the reaction mixture to the surface of a component, and
irradiating the reaction mixture with light, preferably with light of a wavelength of between 180 and 700 nm.
9. A seal attached by foaming to a component in situ, producible
   a) by a method of embodiment 8
   and/or
   b) from a multicomponent system of any of embodiments 1 to 4
   and/or
   c) from a reaction mixture of either of embodiments 5 and 6.
10. A product, more particularly electronic component, housing, preferably control cabinet, lamps, drum or filter housing, comprising a seal of embodiment 9 attached by foaming to a component in situ, preferably produced by a method of embodiment 8.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. The use of a multicomponent system comprising
a) a polyorganosiloxane
b) a polyhydrogenorganosiloxane
c) a photoactivatable catalyst
d) a blowing agent
where the polyhydrogenorganosiloxane b) is assigned to a first component I), and the photoactivatable catalyst c) is assigned to a second component II), which are spatially separate from one another,
for producing a seal attached by foaming to a component in situ, where a reaction mixture resulting through mixing of the components of the multicomponent system is irradiated with light, and wherein the blowing agent d) is a compound having at least one hydroxyl group or is a mixture of compounds having hydroxyl groups, and preferably is water, an alcohol or mixtures thereof.

17. The use of a multicomponent system as claimed in claim 16, wherein the alcohol is a mono-, di- or polyhydric alcohol having 1 to 10 carbon atoms.

18. The use of a multicomponent system as claimed in claim 16, wherein the alcohol includes at least one of methanol, ethanol, propanol isopropanol and butanol.

19. The use of a multicomponent system as claimed in claim 16, wherein the alcohol includes at least one of 1-butanol, 1,4-butanediol, lauryl alcohol, octyl alcohol, 2-ethylhexanol or ethylene glycol.

20. The use of a multicomponent system as claimed in claim 16, wherein the amount of the blowing agent d) is
0.01 to 10.0 wt %,
based on the total amount of the multicomponent system.

21. The use of a multicomponent system as claimed in claim 16, wherein the amount of the blowing agent d) is 0.1 to 5.0 wt % based on the total amount of the multicomponent system.

22. The use of a multicomponent system as claimed in claim 16, wherein the amount of the blowing agent d) is 0.2 to 3.0 wt % based on the total amount of the multicomponent system.

23. The use of a multicomponent system as claimed in claim 16, wherein the blowing agent d) is assigned to the second component II).

24. The use of a multicomponent system as claimed in claim 16, wherein the polyorganosiloxane a) has on average at least one of:
at least two unsaturated organic groups per molecule,
at least two vinyl groups per molecule,
two terminal vinyl groups per molecule.

25. The use of a multicomponent system as claimed in claim 16, wherein the photoactivatable catalyst is a photoactivatable hydrosilylation catalyst which comprises at least one metal selected from the group consisting of platinum, palladium, rhodium, nickel, iridium, and ruthenium, preferably platinum.

26. The use of a multicomponent system as claimed in claim 16, wherein the photoactivatable catalyst is at least one of an organometallic compound, an η-diolefin-σ-aryl-platinum complex, a (η-diolefin)-(sigma-aryl)-platinum complex and a (η-diolefin)-(sigma-alkyl)-platinum complex.

27. The use of a multicomponent system as claimed in claim 16, for producing at least one of electronic components, housings, control cabinets, lamps, barrel housings and filter housings.

28. The use of a multicomponent system as claimed in claim 16, wherein the multicomponent system additionally comprises at least one more filler.

29. The use of a multicomponent system as claimed in claim 16, wherein the multicomponent system additionally includes at least one additive.

30. The use of a multicomponent system as claimed in claim 29, wherein the at least one additive is an additive for cell control in foams.

31. The use of a multicomponent system as claimed in claim 16, wherein the polyorganosiloxane a) is a polydimethylsiloxane in which the methyl groups are present at not less than 90 mol %, based on the Si atoms, preferably 90 to 99.99 mol %.

32. The use of a multicomponent system as claimed in claim 16, wherein polyorganosiloxane a) is assigned to at least one of the first component I) and the second component II).

33. The use of a multicomponent system as claimed in claim 16, wherein the polyhydrogenorganosiloxane b) has an SiH content of more than 2 mmol/g based on the total weight of the polyhydrogenorganosiloxane b) used in each case.

34. The use of a multicomponent system as claimed in claim 16, wherein the polyhydrogenorganosiloxane b) has an SiH content of 10 to 16 mmol/g, based on the total weight of the polyhydrogenorganosiloxane b) used in each case.

35. The use of a multicomponent system as claimed in claim 16, wherein the light has a wavelength of between 180 and 700 nm.

36. The use of a multicomponent system as claimed in claim 35, wherein the light has a wavelength of between 200 and 500 nm.

37. A method for producing a seal attached by foaming to a component in situ, comprising the following steps: —providing or producing a multicomponent system as defined in claim 16,
mixing the components of the multicomponent system provided or produced, to form a reaction mixture,
applying the reaction mixture to the surface of a component, and
irradiating the reaction mixture with light, preferably with light of a wavelength of between 180 and 700 nm,
where a seal attached by foaming to a component in situ is obtained.
